(19) United States
(12) Patent Application Publication
(10) Pub. No.: US 2009/0119527 A1
(43) Pub. Date: May 7, 2009

(54) PORTABLE COMPUTER AND METHOD OF CONTROLLING POWER SAVING MODE OF PORTABLE COMPUTER

(75) Inventor: Yang-Hoon KIM, Seongnam-si (KR)

Correspondence Address: BIRCH STEWART KOLASCH & BIRCH, PO BOX 747, FALLS CHURCH, VA, 22040-0747, US

(73) Assignee: LG Electronics Inc., Seoul City (KR)

(21) Appl. No.: 12/178,477

(22) Filed: Jul. 23, 2008

(30) Foreign Application Priority Data
Nov. 1, 2007 (KR) 10-2007-0111148

(51) Int. Cl. G06F 1/32

(52) U.S. Cl. 713/323

(57) ABSTRACT

A portable computer and a method of controlling a power saving mode of the portable computer, in which an embedded controller directly turns off system power without system wake up operation in a process of turning off the system power or switching a power saving mode when battery power is decreased. The computer includes a control unit for notifying whether a power saving mode is a hybrid sleep mode when the portable computer enters the power saving mode; and an embedded controller for detecting whether the remaining amount of a battery decreases below a threshold value or a predetermined period of time has passed after the computer enters the power saving mode to perform hibernation or turn off system power, if the power saving mode notified from the control unit is the hybrid sleep mode.

### CROSS REFERENCE TO RELATED APPLICATIONS

The present application is related to, and claims priority to, Korean patent application No. 10-2007-0111148, filed on Nov. 1, 2007, the entire contents of which are hereby incorporated by reference.

### BACKGROUND OF THE INVENTION

1. Field of the Invention

The present invention relates to a portable computer and a method of controlling a power saving mode of the portable computer, in which an embedded controller directly turns off system power without system wake up operation in a process of turning off the system power or switching a power saving mode when battery power is decreased.

2. Description of the Related Art

Although different operating systems supports different power saving modes in portable computers, a power saving mode of a portable computer generally includes S3 (suspend to RAM: a suspended mode) and S4 (suspend to disk: a maximum power saving mode or a hibernation mode) levels of power management levels defined by Advanced Configuration and Power Interface (ACPI) in most cases.

The S3 level is a power saving mode in which power is consistently supplied to RAM (main memory of a portable computer) in order to maintain data stored in the RAM, while the S4 level is a power saving mode in which data stored in the RAM is securely saved in a hard disk and the power supplied to the system including RAM is blocked.

Accordingly, the power saving mode of S3 level is advantageous in that time needed to return to a normal operation mode is reduced since data is directly accessed from the RAM when the portable computer returns to the normal operation mode. On the other hand, the S3 level is disadvantageous in that since power is consistently supplied to the RAM, battery power is continuously consumed, and if the battery power is completely consumed, the power to be supplied to the RAM is insufficient and thus data could be lost.

In the meantime, the S4 level is advantageous in that the portable computer enters a power saving mode after saving data into a hard disk and thus permanent loss of data can be prevented. However, the S4 level is disadvantageous in that time needed to return to the normal operation mode is extended since data is restored from the hard disk and then the portable computer returns to the normal operation mode, and a hard disk space as large as the RAM is needed since the data in the RAM should be stored in the hard disk.

Accordingly, the recently developed Windows Vista operating system supports a hybrid sleep mode together with power management modes of the S3 and S4 levels described above.

The hybrid sleep mode is a power saving mode in which the S3 and S4 levels are combined.

That is, since power is supplied even after the portable computer enters a power saving mode as it is in the S3 level, the portable computer may rapidly return to a normal operation mode. In addition, when the portable computer enters the power saving mode, a state of the system is saved in a hard disk as it is in the S4 level, data may be further stably maintained.

In the hybrid sleep mode, since data stored in the RAM is saved in the hard disk as it is immediately before the portable computer enters a power saving mode, a disk space as large as the RAM is needed.

On the other hand, since power is not supplied to the central processing unit after the portable computer enters the power saving mode, an embedded controller performs power control, command input detection, and system wake up operation.

If power shortage of a battery is detected after the portable computer enters the power saving mode, the embedded controller resumes supplying power to the system to return to the normal operation mode, and the central processing unit turns off system power in the normal operation mode depending on settings.

On the other hand, if power shortage of the battery is detected in the hybrid sleep mode, the system power may be turned off, or the power saving mode may be changed (e.g., performing hibernation) to a state of supplying power as in the S4 level. Also, at this time, if the embedded controller resumes supplying power to the system and restores the system into the normal operation mode, the central processing unit turns off the system power or performs hibernation.

However the above related art has the following problems.

That is, there is a problem in that if the power shortage of the battery is detected in the hybrid sleep mode, power is unnecessarily consumed to restore the system into the normal operation mode.

Further, since power is consumed in a state where battery power is insufficient, an abnormal system shutdown may occur.

Furthermore, if the portable computer is set to perform hibernation and enter a power saving mode of S4 level when battery power is insufficient in the hybrid sleep mode, there is a problem in that the battery power is completely consumed while the system is returning to the normal operation mode and thus the system power is turned off (S5 level of ACPI power management levels: booting time is long as compared with a case where the computer returns from the S4 level, and user environments before entering the power saving mode cannot be restored).

### SUMMARY OF THE INVENTION

Accordingly, the present invention is conceived to solve the problems in the prior art as described above. An object of the present invention is to provide a portable computer, a computer program product, and a method of controlling a power saving mode thereof, in which when power shortage of a battery is detected in a hybrid sleep mode, the portable computer is not returned to a normal operation mode, but the power saving mode is changed, or system power is turned off, thereby preventing unnecessary power consumption.

Another object of the present invention is to provide a portable computer, a computer program product, and a method of controlling a power saving mode thereof, in which when power shortage of a battery is detected in a hybrid sleep mode, minimum power is consumed to change the power saving mode, thereby preventing an undesired shutdown of system power.

A portable computer according to the present invention comprised a control unit for notifying whether a power saving mode corresponds to a hybrid sleep mode when the portable computer enters the power saving mode; and an embedded controller for detecting whether the remaining amount of a battery decreases below a threshold value or a predetermined period of time has passed after the portable computer enters the power saving mode to perform hibernation or turn off system power, if the power saving mode notified from the control unit is the hybrid sleep mode.

Here, in the hybrid sleep mode, system states may be stored in a random access memory (RAM) and a hard memory when the portable computer enters the power saving mode, and power supply to the RAM may be continued after the portable computer enters the power saving mode.

The notification of whether the power saving mode corresponds to the hybrid sleep mode may be performed by executing an application program, which is programmed so that the control unit detects whether the power saving mode is the hybrid sleep mode and notify the embedded controller thereof.

In addition, the hibernation may be performed or the system power may be turned off by executing firmware, wherein the firmware is programmed so that the embedded controller detect whether the remaining amount of the battery decreases below the threshold value or the predetermined period of time has passed after the portable computer enters the power saving mode and perform the hibernation or turn off the system power if the power saving mode notified from the control unit is the hybrid sleep mode.

Further, whether the hibernation is performed or the system power is turned off may be determined by a user setting.

In a portable computer according to the present invention, hibernation is performed or system power is turned off without return to a normal operation mode, if it is detected that the remaining amount of a battery decreases below a threshold value or a predetermined period of time has passed after the portable computer enters a hybrid sleep mode.

At this time, in the hybrid sleep mode, data stored in RAM may be copied to a hard disk when the portable computer enters a power saving mode, and power supply to the RAM may be after the portable computer enters the power saving mode.

In addition, the portable computer may enter the hybrid sleep mode if a command for entering the power saving mode is detected while executing a program that needs to save data.

The portable computer may enter the hybrid sleep mode if the remaining amount of the battery is lower than a set value when a command for entering the power saving mode is detected.

Also, the portable computer may enter the hybrid sleep mode if a command for entering the power saving mode is detected while only battery power is supplied.

A computer program product and method of controlling a power saving mode of a portable computer according to the present invention comprised the steps of (A) satisfying conditions for entering a hybrid sleep mode; (B) notifying an embedded controller that a power saving mode to be entered corresponds to the hybrid sleep mode; (C) entering the hybrid sleep mode; and (D) changing a system state by the embedded controller if the remaining amount of a battery decreases below a threshold value or a predetermined period of time has passed after entering the hybrid sleep mode.

Step (A) may be performed if a command for entering the hybrid sleep mode is inputted, the remaining amount of the battery is detected to be lower than the threshold value, or a predetermined period of time has passed without a user input.

Step (D) may be accomplished if the embedded controller turns off system power or performs hibernation.

In the hybrid sleep mode, system states may be stored in a RAM and a hard memory when the portable computer enters the power saving mode, and power may be supplied to the RAM even after the portable computer enters the power saving mode.

A method of controlling a power saving mode of a portable computer according to the present invention comprises the steps of (a) satisfying conditions for entering a power saving mode; (b) selecting a type of the power saving mode to be entered; (c) notifying an embedded controller that the power saving mode to be entered corresponds to a hybrid sleep mode if the hybrid sleep mode is selected in step (b); (d) entering the hybrid sleep mode; and (d) changing a system state by the embedded controller if the remaining amount of a battery decreases below a threshold value or a predetermined period of time has passed after entering the hybrid sleep mode.

At this time, step (a) may be accomplished if a predetermined period of time has passed without a user input or a user command for entering the power saving mode is detected.

In addition, step (e) may be accomplished if the embedded controller turns off system power or performs hibernation.

Step (b) may comprise the steps of searching for programs that are being executed when the conditions for entering the power saving mode are satisfied; and selecting the hybrid sleep mode if a program that needs to save data is included in the searched programs, and selecting a suspended mode if all the executed programs do not need to save data.

Step (b) may comprise the steps of measuring the remaining amount of a battery; and selecting the hybrid sleep mode if the measured remaining amount of the battery is detected to be lower than a set value, and selecting a suspended mode if the measured remaining amount of the battery is detected to be higher than the set value.

Step (b) may comprise the steps of detecting whether AC power is supplied; and selecting a suspended mode if the AC power is being supplied, and selecting the hybrid sleep mode if the AC power is not supplied.

As described above in detail, in the portable computer and the method of controlling a power saving mode thereof according to the present invention, the following advantages can be expected.

That is, since the system need not return to a normal operation mode in order to shut down the system or perform hibernation when battery power is insufficient in the hybrid sleep mode, it is advantageous in that unnecessary power consumption and an abnormal shutdown of the system can be prevented.

Furthermore, in the portable computer and the method of controlling a power saving mode thereof according to the present invention, since power is not excessively consumed in order to perform hibernation when battery power is insufficient in the hybrid sleep mode, an undesired shutdown of the system power is prevented, and thus, it is advantageous in that loss of user environments immediately before the portable computer enters a power saving mode can be prevented.

### BRIEF DESCRIPTION OF THE DRAWINGS

FIG. 1 is a block diagram showing a configuration of a portable computer according to a specific embodiment of the present invention;

FIG. 2 is a flowchart illustrating a method of controlling a power saving mode of a portable computer according to a specific embodiment of the present invention step by step;

FIG. 3 is a flowchart illustrating a first embodiment of step 120 of FIG. 2;

FIG. 4 is a flowchart illustrating a second embodiment of step 120 of FIG. 2; and

FIG. 5 is a flowchart illustrating a third embodiment of step 120 of FIG. 2.

### DESCRIPTION OF THE PREFERRED EMBODIMENT

Hereinafter, a portable computer according to a specific embodiment of the present invention will be described in detail with reference to the accompanying drawings.

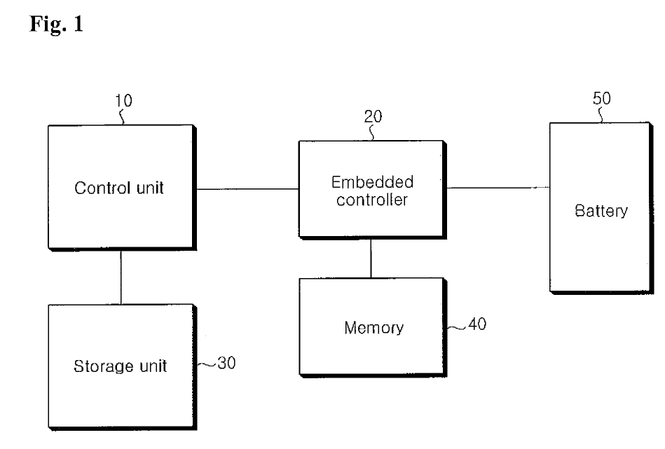

FIG. 1 is a block diagram showing the configuration of the portable computer according to the specific embodiment of the present invention.

As shown in FIG. 1, the portable computer according to the specific embodiment of the invention comprises a control unit 10. The control unit 10 is a central processing unit or microprocessor of the portable computer, which interprets commands, calculates and compares data, and controls and coordinates a series of processes for receiving and processing data from a variety of input devices and sending results thereof to an output device.

In addition, the control unit 10 causes the operating system of the portable computer to operate. Accordingly, the control unit 10 controls the portable computer based on the operating system.

Particularly, the control unit 10 operates a variety of power saving modes defined by the operating system. Although the power saving modes are different in each operating system, the power saving mode of the portable computer according to the specific embodiment of the present invention includes a hybrid sleep mode.

The hybrid sleep mode is a power saving mode in which S3 (suspend to RAM: a suspended mode) and S4 (suspend to disk: a maximum power saving mode or a hibernation mode) levels of power management levels defined by ACPI are combined.

That is, in this method, the portable computer may rapidly return to a normal operation mode by supplying power to RAM even after the portable computer enters a power saving mode as in the S3 level, and further stably maintains data by saving the state of the system in a hard disk as in the S4 level.

In the hybrid sleep mode, since data stored in the RAM is saved in the hard disk as it is immediately before the portable computer enters a power saving mode, a disk space as large as the RAM is needed.

In the meantime, since the control unit 10 is not supplied with power after the portable computer enters the power saving mode, an embedded controller 20 takes charge of the power control of the system after the portable computer enters the power saving mode.

The embedded controller 20, which is a control means provided in the portable computer separately from the control unit 10, charges and discharges a battery in the portable computer, supplied with power even after the system is shut down, continuously operates and manages the battery, and detects input of the power button from a user.

Accordingly, the embedded controller 20 receives a command for entering the power saving mode from the control unit 10 and manages power following the command.

Meanwhile, since power is continuously supplied to the RAM in the hybrid sleep mode, the remaining amount of the battery continuously decreases as time passes after the portable computer enters the power saving mode.

Therefore, in order to prevent continuous consumption of power, the portable computer shuts down power supplied to the RAM and performs hibernation or turns off system power if a predetermined period of time has passed after the portable computer enters the hybrid sleep mode or the remaining amount of the battery decreases below a threshold value.

At this time, the hibernation causes all of the power supplied to the RAM as in the S4 level of the ACPI power management levels to be shut down and the power saving mode to be changed into a state similar to a system off state.

If the hibernation is performed, the battery is not nearly consumed as in the system power off state. However, since the system is booted while the data stored in the RAM is saved in the hard disk as it is, booting speed is faster as compared with a case where the operating system is rebooted after the system power is turned off.

At this time, the present invention is different from a prior art in that the embedded controller 20 detects whether a predetermined period of time has passed or the remaining amount of the battery decreases below a threshold value and then performs hibernation or turns off the system power.

That is, unlike the prior art in which a system returns to a normal operation mode in order to perform hibernation or turn off the system power and then the central processing unit performs hibernation or turns off the system power, in the present invention, the embedded controller 20 directly performs the hibernation and turns off the system power, and thus, a return process of the system to a normal operation mode can be omitted.

To this end, when the portable computer enters the power saving mode, the control unit 10 notifies the embedded controller 20 of whether the power saving mode to be entered corresponds to the hybrid sleep mode. It is different in that the embedded controller cannot distinguish the hybrid sleep mode from a mode corresponding to the S3 level of the ACPI power management levels in the prior art.

At this time, the control unit 10 accesses a storage unit 30 and executes an application program to notify the embedded controller 20 of whether the power saving mode to be entered corresponds to the hybrid sleep mode.

Here, the storage unit 30 is a general storage means or memory means provided in the portable computer, and may be a hard disk or RAM onto which data is copied from the hard disk.

The application program is designed to identify the type of the power saving mode to be entered and notify the embedded controller 20 of the type.

In the meantime, the embedded controller 20 is notified of whether the power saving mode to be entered corresponds to the hybrid sleep mode by the control unit 10 as described above. If the power saving mode to be entered corresponds to the hybrid sleep mode, the portable computer enters the hybrid sleep mode.

That is, if the portable computer is going to enter the hybrid sleep mode, the control unit 10 saves data stored in the RAM in the hard disk as it is and simultaneously commands the embedded controller 20 for the portable computer to enter a power saving mode corresponding to the S3 level. At the same time, the control unit 10 transmits a signal indicating that the power saving mode to be entered is the hybrid sleep mode to the embedded controller 20.

Then, the embedded controller 20 determines whether the power saving mode currently entered is a power saving mode corresponding to the S3 level or the hybrid sleep mode according to the transmitted signal. If it is determined to be the hybrid sleep mode and it is detected that a predetermined period of time has passed or the remaining amount of the battery is lower than a threshold value, the hibernation is performed or the system power is turned off. To this end, the embedded controller 20 is provided with a memory 40 for storing firmware designed to perform such operation.

The firmware is programmed so that the embedded controller 20 determines whether the power saving mode corresponds to the hybrid sleep mode based on the signal received from the control unit 10 and the embedded controller 20 directly performs the hibernation or turns off the system power.

In the meantime, the memory 40 in which the firmware is stored may be a non-volatile memory such as a read only memory (ROM) device, a flash memory, or the like.

The embedded controller 20 performs the hibernation or turns off the system power as described above when a predetermined period of time has passed after the portable computer enters the hybrid sleep mode or the remaining amount of the battery is detected to be lower than a threshold value.

At this time, a case where a predetermined period of time has passed means that the predetermined period of time has passed without detecting a user command or a key input after the portable computer enters the hybrid sleep mode.

A case where the remaining amount of the battery is detected to be lower than a threshold value means that the remaining capacity of the battery 50 provided in the portable computer is detected to be lower than a predetermined value by means of a sensor or the like.

At this time, the method of detecting the remaining capacity of the battery 50 may be accomplished through a general method of measuring voltage or current of a battery, so that the description thereof will be omitted.

Conditions that should be satisfied for the embedded controller 20 to perform hibernation or turn off the system power, i.e., passage of a predetermined period of time or decrease in the remaining amount of the battery may be changed depending on settings.

If a predetermined period of time has passed or the remaining amount of the battery decreases, the embedded controller 20 is allowed to perform the hibernation or turn off the system power.

In addition, it is also possible to perform the hibernation or turn off the system power by the first satisfied condition of the two conditions.

Further, the predetermined period of time and the threshold value can be changed as a user wishes, and a user interface may be provided to modify such settings.

It may also be selectively set whether the embedded controller 20 performs the hibernation or turns off the system power if a predetermined period of time has passed after the portable computer enters the hybrid sleep mode or the remaining amount of the battery decreases below a threshold value. In addition, a user interface for setting the selection may be provided.

At this time, it may be set for the embedded controller 20 to maintain the current power saving mode without performing hibernation or turning off the system power.

Hereinafter, a specific embodiment of the method of controlling a power saving mode of a portable computer according to the present invention will be described in detail with reference to the accompanying drawings.

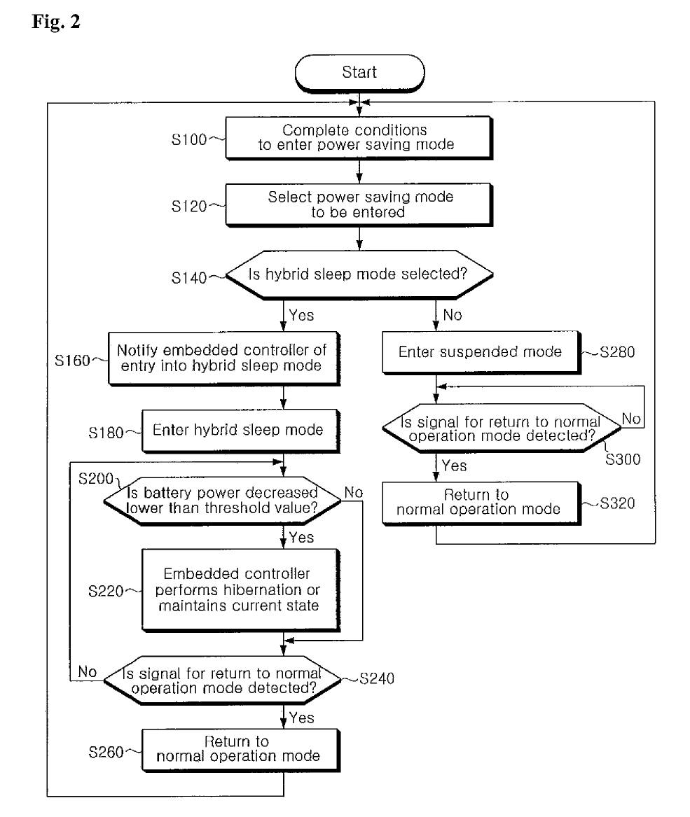

FIG. 2 is a flowchart illustrating the method of controlling a power saving mode of a portable computer according to the specific embodiment of the present invention step by step.

As shown in FIG. 2, the method of controlling a power saving mode of a portable computer according to the specific embodiment of the present invention starts from a step of satisfying conditions for entering a power saving mode from a normal operation mode (step S100).

The step of satisfying conditions for entering a power saving mode of step S100 may be performed when a user inputs a command for entering a power saving mode or a user input is not detected within a predetermined period of time.

The conditions for entering a power saving mode of step S100 may be set differently depending on the type of the power saving mode.

Then, if the conditions for entering a power saving mode is satisfied in step S100, the control unit 100 selects a power saving mode to be entered (step S120).

If different entering conditions are set for different power saving modes, the control unit 10 performs a series of processes in order to enter a corresponding power saving mode as soon as the conditions are satisfied.

In the meantime, in step S120, the type of power saving mode to be entered may be differently determined depending on the type of program being executed in the system, the remaining amount of the battery detected on entering the power saving mode, whether AC power is supplied, and the like.

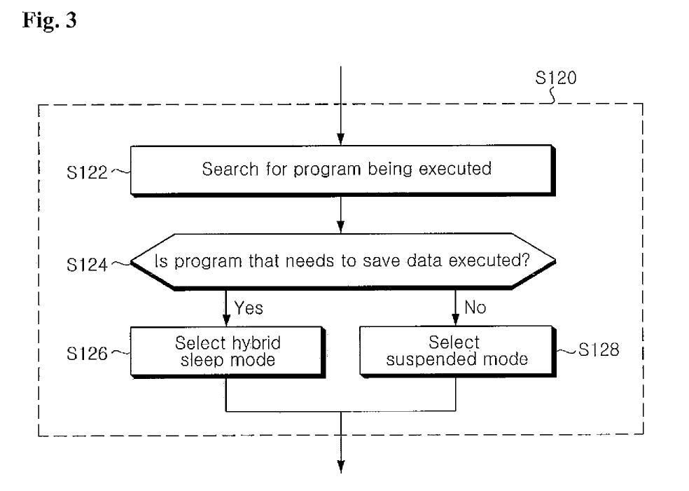

This will be described later with reference to FIGS. 3 to 5.

If the power saving mode selected in step S120 is a hybrid sleep mode (step S140), the control unit 10 notifies the embedded controller 20 of the entry into the hybrid sleep mode (step S160).

At this time, the control unit 10 possesses a reference value for each power saving mode, converts a corresponding reference value to a signal depending on the type of a power saving mode to be entered, and transmits the converted signal to the embedded controller 20.

Here, the control unit 10 accesses the storage unit 30 and executes an application program, and the application program serves to determine whether the power saving mode to be entered by the control unit 10 is the hybrid sleep mode and to notify the embedded controller 20 of whether the power saving mode is the hybrid sleep mode.

Then, after performing step S160, the portable computer enters the hybrid sleep mode (step S180).

The portable computer may enter the hybrid sleep mode in such a manner that the control unit 10 copies data stored in the RAM to the hard disk as it is immediately before the portable computer enters the hybrid sleep mode and the power supplied to the RAM is maintained.

Here, although the portable computer enters the power saving mode as described above, the power supplied to the embedded controller 20 is not blocked.

Accordingly, if the power supplied to the control unit 10 is blocked as the portable computer enters the hybrid sleep mode, the embedded controller 20 performs system control including power management.

If the portable computer enters the hybrid sleep mode, the embedded controller 20 monitors whether battery power decreases below a threshold value (step S200).

That is, the embedded controller 20 monitors whether the remaining capacity of the battery 50 provided in the portable computer decreases below a predetermined threshold value. If the remaining amount of the battery is detected to be lower than the predetermined value, the embedded controller 20 blocks the power supplied to the RAM and performs hibernation in order to prevent the consumption of the remaining amount of the battery that has already been decreased below the threshold value.

Accordingly, power is consistently supplied to the RAM, and continuous discharge of the battery is prevented.

At this time, the threshold value may be set to a value of the remaining amount of the battery with which the power supplied to the RAM is difficult to be maintained due to insufficient battery power, or set to a further larger value in order to save the battery power.

Here, in step S220, the current state may be maintained without performing hibernation depending on user settings. That is, although the battery power decreases below the threshold value, power supply to the RAM can be continued.

In the meantime, if it is not detected that the battery power is decreased below the threshold value in step S200, power supply to the RAM is continued, and the current power saving mode is maintained.

Then, the embedded controller 20 continuously monitors whether a signal for return to a normal operation mode is inputted (step S240).

After the portable computer enters the hybrid sleep mode, the embedded controller 20 monitors whether a button for releasing the hybrid sleep mode is pressed, or whether separate input operation is detected. If the above operation is detected, the embedded controller 20 resumes the power supply to the system and returns the portable computer to the normal operation mode (step S260).

Accordingly, the control unit 10 restarts to operate.

In the meantime, step S200 may be performed in another method other than a method of monitoring whether the battery power decreases below a threshold value.

That is, from the moment when the portable computer enters the power saving mode, it is monitored whether a predetermined period of time has passed without detecting a user command or input for return to a normal operation mode. If a predetermined period of time has passed, the embedded controller 20 may perform hibernation in order to prevent complete discharge of the battery.

In the meantime, the embedded controller 20 may turn off the system power instead of performing hibernation in step S220.

At this time, in order to perform steps 200 to 220, the embedded controller is provided with the memory 40, and the memory 40 may store firmware designed to perform the steps.

In addition, depending on settings, steps 200 to 220 may be omitted.

Meanwhile, if the selected power saving mode is not the hybrid sleep mode in step S140, the portable computer may enter into a suspended mode (a power saving mode of S3 level). Depending on situations, the portable computer may enter into a maximum power saving mode (a power saving mode of S4 level).

In these cases, the signal for return to the normal operation mode is detected in the same manner as in a prior art (step S300). If the signal for return to the normal operation mode is detected, the portable computer returns to the normal operation mode (step S320), whereas if the signal for return to the normal operation mode is not detected, a corresponding power saving mode is maintained.

Hereinafter, a method of controlling a power saving mode of a portable computer according to the specific embodiment of the invention described with reference to FIG. 2 will be described with reference to FIGS. 3 to 5.

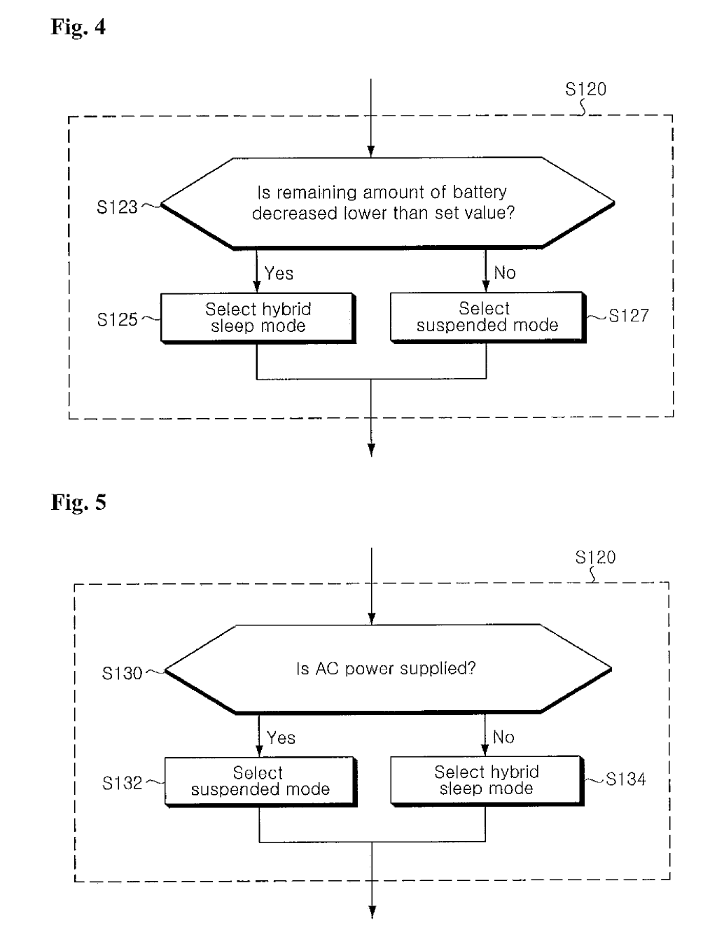

FIG. 3 is a flowchart illustrating a first embodiment of step 120 of FIG. 2 step by step, FIG. 4 is a flowchart illustrating a second embodiment of step 120 of FIG. 2 step by step, and FIG. 5 is a flowchart illustrating a third embodiment of step 120 of FIG. 2 step by step.

If the conditions for entering a power saving mode are satisfied in step S100 of FIG. 2, the control unit 10 may perform the step of selecting a power saving mode to be entered (step S120). In a case where different entry conditions are set for each power saving mode, the operation for directly entering a corresponding power saving mode may be performed without performing the step of selecting a power saving mode.

As shown in FIG. 3, the control unit 10 may first search for programs that are being executed in order to determine a power saving mode to be entered (step S122).

The control unit 10 may divide a variety of application programs into application programs that need to save data and application programs that do not need to save data.

For example, application programs related to document editing absolutely need to save contents of work. However, since web browser, simple display, or playback programs merely access data stored in a hard memory of a server or a computer, a computer user can obtain the same data although the contents are not necessarily saved.

Accordingly, the control unit 10 determines application programs related to document editing, image editing, or the like as application programs that need to save data, and other application programs as application programs that do not need to save data.

If it is determined that the application programs searched as being executed in step S122 include programs that need to save data (step S124), the control unit 10 selects the entry into the hybrid sleep mode (step S126).

For the application programs that need to save data, corresponding data are previously saved in the hard disk when the portable computer enters the power saving mode, so that the data may not to be lost.

In the meantime, if it is determined that application programs that are being executed do not include programs that need to save data in step S124, the control unit 10 may select the entry into the suspended mode (step S128).

Then, if the control unit 10 determines the type of power saving mode to be entered through the steps described above, steps S140 to S320 described in FIG. 2 are performed.

On the other hand, step S120 described in FIG. 2 may be performed as shown in FIG. 4.

That is, the control unit 10 detects the remaining amount of the battery when the conditions for entering a power saving mode are satisfied. It is determined whether the detected remaining amount of the battery is decreased below a set value (step S123). At this time, the set value is different from the threshold value of the remaining amount of the battery described in FIG. 2.

The set value is a value for selecting the type of power saving mode and is a value of the remaining amount of the battery that is previously set to cope with a case where the portable computer enters the suspended mode since the remaining amount of the battery is decreased below a predetermined level and thus supply of power may be influenced even by consumption of power supplied to the RAM.

Here, the set value may be larger than the threshold value.

If the remaining amount of the battery is detected to be lower than the set value in step S123, the control unit 10 selects the entry into the hybrid sleep mode (step S124) and prevents loss of data incurred by complete discharge of the battery.

Then, if the remaining amount of the battery is detected to be higher than the set value in step S123, the control unit 10 may select the suspended mode (step S127) since the battery is less likely to be fully discharged.

On the other hand, step S120 described in FIG. 2 may be performed as shown in FIG. 5.

That is, the control unit 10 detects whether AC power is supplied to the system when conditions for entering a power saving mode are satisfied (step S130).

Then, if AC power is supplied to the system in step S130, the control unit 10 selects the suspended mode since it is less likely to lose data by power consumption (step S132).

However, if AC power is not supplied and the system operates only by the battery power, since it is worried that data may be lost due to complete discharge of the battery, the control unit 10 selects the hybrid sleep mode, so that the data can be saved in a hard memory (step S134).

Then, the various embodiments described above with reference to FIGS. 3 to 5 may be combined to selects a power saving mode.

Depending on the type of the power saving mode selected through a series of steps described above, the other steps described with reference to FIG. 2 are performed.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, such embodiments are implemented by controller.

For a software implementation, the embodiments described herein may be implemented with separate software modules, such as procedures and functions, each of which perform one or more of the functions and operations described herein. The software codes can be implemented with a software application written in any suitable programming language and may be stored in memory and executed by a controller or processor.

The scope of the present invention is not limited to the embodiments described and illustrated above but is defined by the appended claims. It will be apparent that those skilled in the art can make various modifications and changes thereto within the scope of the invention defined by the claims.

What is claimed is:

1. A portable computer, comprising:
a battery;
a control unit configured to notify an embedded controller whether a power saving mode is a hybrid sleep mode when the portable computer enters the power saving mode to perform hibernation or turn off system power; and
the embedded controller operatively connected to the control unit and configured to detect whether a remaining amount of the battery decreases below a threshold value or a predetermined period of time has passed after the portable computer enters the power saving mode if the power saving mode notified from the control unit is the hybrid sleep mode.

2. The portable computer as claimed in claim 1, further comprising:
a random access memory (RAM); and
a hard memory,
wherein in the hybrid sleep mode, system states are stored in the random access memory (RAM) and the hard memory when the portable computer enters the power saving mode, and a supply of power to the RAM is continued after the portable computer enters the power saving mode.

3. The portable computer as claimed in claim 2, wherein the control unit is configured to execute an application program, the application program being programmed so that the control unit detects whether the power saving mode is the hybrid sleep mode and notifies the embedded controller thereof.

4. The portable computer as claimed in claim 3, further comprising:
firmware,
wherein the hibernation is performed or the system power is turned off by executing the firmware, the firmware being programmed so that the embedded controller detects whether the remaining amount of the battery decreases below the threshold value or the predetermined period of time has passed after the portable computer enters the power saving mode, and performs the hibernation or turns off the system power, if the power saving mode notified from the control unit is the hybrid sleep mode.

5. The portable computer as claimed in claim 4, wherein whether the hibernation is performed or the system power is turned off is determined by a user setting.

6. A portable computer, comprising:
a battery; and
a control device configured to place the portable computer into hibernation or to turn off system power without return to a normal operation mode, if the control device detects that a remaining amount of the battery decreases below a threshold value or a predetermined period of time has passed after the portable computer enters a hybrid sleep mode.

7. The portable computer as claimed in claim 6, further comprising:
a RAM; and
a hard disk,
wherein in the hybrid sleep mode, data stored in the RAM is copied to the hard disk when the portable computer enters a power saving mode, and a supply of power to the RAM is continued after the portable computer enters the power saving mode.

8. The portable computer as claimed in claim 7, wherein the portable computer enters the hybrid sleep mode if a command for entering the power saving mode is detected by the control device while executing a program that saves data.

9. The portable computer as claimed in claim 7, wherein the portable computer enters the hybrid sleep mode if the remaining amount of the battery is lower than a set value when a command for entering the power saving mode is detected by the control device.

10. The portable computer as claimed in claim 7, wherein the portable computer enters the hybrid sleep mode if a command for entering the power saving mode is detected by the control device while only battery power is supplied.

11. A method of controlling a power saving mode of a portable computer, comprising the steps of:
(A) satisfying predetermined conditions for entering a hybrid sleep mode;
(B) notifying an embedded controller that a power saving mode to be entered corresponds to the hybrid sleep mode;
(C) entering the hybrid sleep mode; and
(D) changing a system state of the portable computer by the embedded controller if a remaining amount of a battery of the portable computer decreases below a threshold value or a predetermined period of time has passed after entering the hybrid sleep mode.

12. The method as claimed in claim 11 wherein step (A) is performed if a command for entering the hybrid sleep mode is inputted, the remaining amount of the battery is detected to be lower than the threshold value, or the predetermined period of time has passed without a user input.

13. The method as claimed in claim 11, wherein step (D) is accomplished if the embedded controller turns off system power or performs hibernation.

14. The method as claimed in claim 11, wherein in the hybrid sleep mode, system states are stored in a RAM and a hard memory of the portable computer when the portable computer enters the power saving mode, and power is supplied to the RAM even after the portable computer enters the power saving mode.

15. A method of controlling a power saving mode of a portable computer, comprising the steps of:
(a) satisfying predetermined conditions for entering a power saving mode;
(b) selecting a type of the power saving mode to be entered;
(c) notifying an embedded controller that the power saving mode to be entered corresponds to a hybrid sleep mode if the hybrid sleep mode is selected in step (b);
(d) entering the hybrid sleep mode; and
(d) changing a system state of the portable computer if a remaining amount of a battery of the portable computer decreases below a threshold value or a predetermined period of time has passed after entering the hybrid sleep mode.

16. The method as claimed in claim 15, wherein step (a) is accomplished if a predetermined period of time has passed without a user input or a user command for entering the power saving mode is detected.

17. The method as claimed in claim 15, wherein step (e) is accomplished if system power is turned off or if hibernation is performed.

18. The method as claimed in claim 17, wherein step (b) comprises the steps of:
searching for programs that are being executed when the predetermined conditions for entering the power saving mode are satisfied; and
selecting the hybrid sleep mode if a program that saves data is identified and selecting a suspended mode if all the executed programs do not have data to save.

19. The method as claimed in claim 17, wherein step (b) comprises the steps of:
measuring the remaining amount of the battery; and
selecting the hybrid sleep mode if the measured remaining amount of the battery is detected to be lower than a set value, and selecting a suspended mode if the measured remaining amount of the battery is detected to be higher than the set value.

20. The method as claimed in claim 17, wherein step (b) comprises the steps of:
detecting whether AC power is supplied to the portable computer; and
selecting a suspended mode if AC power is being supplied, and selecting the hybrid sleep mode if AC power is not supplied.
